(19) United States
(12) Patent Application Publication
(10) Pub. No.: US 2016/0091878 A1
(43) Pub. Date: Mar. 31, 2016

(54) METHOD OF CONTROLLING ELECTRONIC DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: YI-FANG WU, New Taipei (TW); YI-BO LIU, Shenzhen (CN); YA-BEI ZHANG, Shenzhen (CN); DAN-FENG WU, Shenzhen (CN); YEN-HWONG CHONG, Shenzhen (MY)

(21) Appl. No.: 14/543,537

(22) Filed: Nov. 17, 2014

(30) Foreign Application Priority Data
Sep. 26, 2014 (CN) 201410501164.2

(51) Int. Cl. G05B 15/02

(52) U.S. Cl. CPC G05B 15/02

(57) ABSTRACT

A method for controlling electronic device includes the following blocks. A control signal is received from an earphone jack. A predefined control command corresponding to the control signal is obtained. At least one application associated with the predefined control command is determined whether is initialized. The predefined control command is executed when the at least one application is initialized.

### CROSS-REFERENCE TO RELATED APPLICATIONS

This application claims priority to Chinese Patent Application No. 201410501164.2 filed on Sep. 26, 2014, the contents of which are incorporated by reference herein.

### FIELD

The present invention relates to a method of controlling an electronic device.

### BACKGROUND

Electronic devices, such as smart phones, tablet computers, and laptop computers typically have an earphone jack for outputting audio to an external earphone.

### BRIEF DESCRIPTION OF THE DRAWINGS

Implementations of the present technology will now be described, by way of example only, with reference to the attached figures.

FIG. 1 is a diagrammatic view of an embodiment of an electronic device and two earphone accessories.

FIG. 2 is a block view of the electronic device of FIG. 1.

FIG. 3 is a flowchart of a method of controlling the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

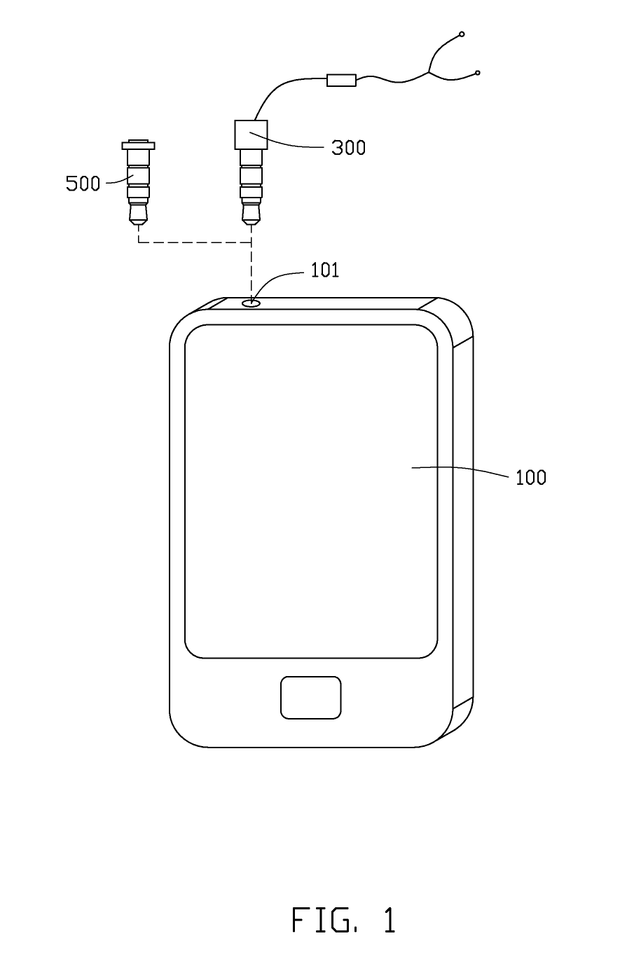

FIG. 1 illustrates an electronic device 100 and two alternative earphone accessories in accordance with an embodiment. The electronic device 100 can be a smart phone, a tablet computer, a laptop computer, a smart watch, a smart glass, and so on. The electronic device 100 defines an earphone jack 101. The electronic device 100 can receive an earphone 300 with earphone cables or receive a smart key 500 with a button without earphone cables. The earphone 300 can be a cable control earphone. The electronic device 100 can execute a predefined application when detecting an input command from the earphone 300. The electronic device 100 can also execute a predefined application when detecting an input command from the smart key 500. The earphone jack 101 can be a standard 3.5 mm earphone jack.

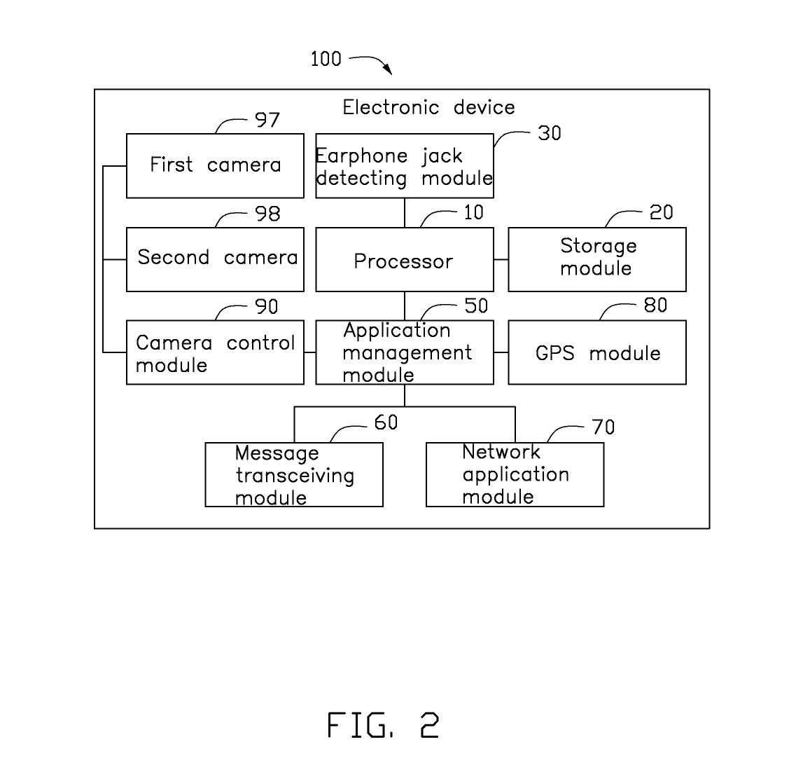

FIG. 2 illustrates a block view of the electronic device 100. The electronic device 100 includes an earphone jack detecting module 30, a processor 10, an application management module 50, a storage module 20, a message transceiving module 60, a network application module 70, a global position system (GPS) module 80, a camera control module 90, a first camera 97, and a second camera 98. The processor 10 is coupled to the earphone jack detecting module 30, the application management module 50, the storage module 20, the GPS module 80, and the camera control module 90. The application management module 50 is coupled to the message transceiving module 60, the network application module 70, the GPS module 80, and the camera control module 90. The camera control module 90 is coupled to the first camera 97 and the second camera 98.

The earphone jack detecting module 30 can detect if an earphone accessory is plugged in the earphone jack 101 and can receive a control signal from the plugged earphone accessory. The control signal can be triggered by pressing a key from the earphone accessory. The control signal can include times of keystrokes of the earphone accessory and lasting period of one keystroke.

The processor 10 can receive the control signal and recognize and the times of keystrokes of the earphone accessory and the lasting period of one keystroke. The processor 10 can obtain a corresponding predefined control command and send the predefined control command to the application management module 50 according to the times of keystrokes of the earphone accessory and the lasting period of one keystroke.

The application management module 50 can receive the predefined control command and detect if at least one application associated with the predefined control command is initialized. The application management module 50 can execute the control command when the at least one application is initialized.

The message transceiving module 60 can transmit and receive a short message through a cellular mobile telephone network. The network application module 70 can include an instant message software communication through the Internet. The GPS module 80 can obtain a location of the electronic device 100. The camera control module 90 can control the first camera 97 and the second camera 98. The first camera 97 and the second camera 98 can be located at two opposite sides of the electronic device 100.

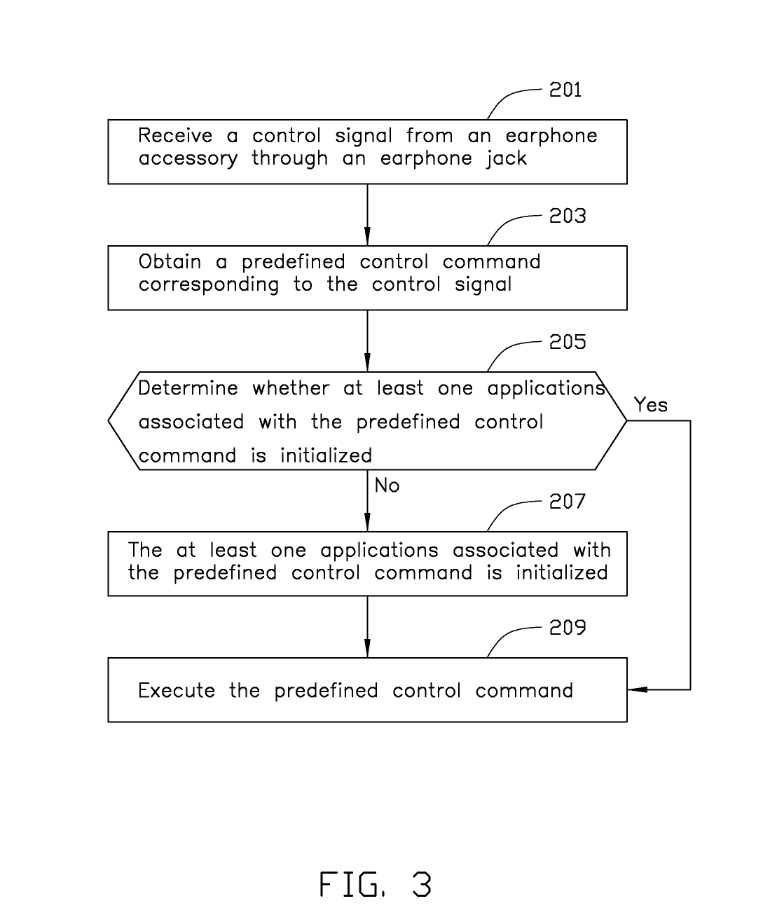

FIG. 3 illustrates a method of controlling an electronic device. The example method is provided by way of example, as there are a variety of ways to carry out the method. The method described below can be carried out using the configurations illustrated in FIG. 2, for example, and various elements of these figures are referenced in explaining the example method. Each block shown in FIG. 3 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method can begin at block 201. The method includes the following blocks.

At block 201, an earphone jack detecting module 30 can receive a control signal from an earphone accessory through an earphone jack.

At block 203, the processor 10 can obtain a predefined control command corresponding to the control signal from a storage module 20.

At block 205, the application management module 50 can determine whether at least one application associated with the predefined control command is initialized. If the at least one application associated with the predefined control command is initialized, the block goes to block 209; if the at least one application associated with the predefined control command is not initialized, the block goes to block 207.

At block 207, the at least one application associated with the predefined control command is initialized.

At block 209, the processor 10 and the application management module 50 execute the predefined control command.

The predefined control command can be stored in the storage module 20. The predefined control command can include the following commands.

Command 1: a message transcieving module 60 stores a predefined message and at least one predefined number. The predefined control command can send the short message to the predefined number through the message transcieving module 60. The predefined number can include one or more phone numbers. The predefined message can be sent to the one or more phone numbers.

Command 2: the command 1 can obtain location information of the electronic device 100 through a GPS module 80 and can send the location information to the predefined number. The location information and the predefined message can be sent to a cloud storage, and the upload location information and the predefined message can be accessed by any authorized users. For example, when the user of electronic device is in dangerous, the command 1 or command 2 can be triggered, a predefined message and location information can uploaded to the cloud storage. Any authorized users can help him when obtain the help.

Command 3: after the predefined control command of command 1 or command 2 is executed, the processor 10 can determine if the predefined message is sent successfully. When the predefined message is sent failed, the camera control module 90 can launch a first camera 97 or a second camera 98 to take phone or video. The message transcieving module 60 can upload the predefined message and the taken photo or video to a predefined contact person or to a website through a network application module 70.

Command 4: an application management module 50 can dial the predefined number. When the predefined number includes at least two phone numbers, the application management module 50 can dial the at least two phone numbers recursively.

Command 5: the camera control module 90 can launch the first camera 97 and the second camera 98 to take at least two photos at the same time.

Command 6: the processor 10 can combine the at least two photos taken in the command 5 when receiving the control signal twice.

Command 7: the camera control module 90 can launch the first camera 97 and the second camera 98 to take videos at the same time.

Command 8: the processor 10 can further stop taking videos in the command 7 when receiving the control signal twice.

Command 9: the camera management module 90 can launch the first camera 97 and the second camera 98 to take two photos at the same time. The processor 10 can detect an average brightness of the two photos. The camera control module 90 can shut down one of the first camera 97 and the second camera 98 with low brightness.

Command 10: the processor 10 can detect brightness within views of the first camera 97 and the second camera 98. The camera control module 90 can employ one camera of the first camera 97 and the second camera 98 with high brightness.

Command 11: the application management module 50 can alarm after a predefined time, such as 5 seconds, until the earphone accessory is unplugged from the electronic device 100.

The embodiments shown and described above are only examples. Many details are often found in the art such as the other features of a method of controlling electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A method for controlling an electronic device, comprising:
receiving a control signal from an earphone jack;
obtaining a predefined control command corresponding to the control signal;
determining whether at least one application associated with the predefined control command is initialized; and
executing the predefined control command when the at least one application is initialized.

2. The method of claim 1, wherein the predefined control command comprises a command of sending a predefined message to a predefined number.

3. The method of claim 2, wherein the predefined control command further comprises a command of obtaining a location information and a command of sending the location information to the predefined number.

4. The method of claim 2, wherein the predefined control command further comprises a command of informing a predefined contact person when the command of sending the predefined message fails.

5. The method of claim 1, wherein the predefined control command comprises a command of taking at least two photos through at least two cameras.

6. The method of claim 5, further comprising combining the at least two photos when receiving the control signal twice.

7. The method of claim 1, wherein the predefined control command comprises a command of lunching at least two cameras to take videos at the same time.

8. The method of claim 7, further comprising stopping taking videos when receiving the control signal twice.

9. The method of claim 1, wherein the predefined control command comprises a command of taking two photos through two cameras, a command of detecting an average brightness of the two photos, and a command of shutting down one of cameras with low brightness.

10. The method of claim 1, further comprising detecting brightness within views of at least two cameras, and employing one camera of the at least two cameras with high brightness.

11. A method for controlling an electronic device, comprising:
receiving a control signal from a smart key through an earphone jack;
obtaining a predefined control command corresponding to the control signal; and
executing the predefined control command.

12. The method of claim 11, wherein the predefined control command comprises a command of sending a predefined message to a predefined number.

13. The method of claim 12, wherein the predefined control command further comprises a command of obtaining a location information and a command of sending the location information to the predefined number.

14. The method of claim 12, wherein the predefined control command further comprises a command of informing a predefined contact person when the command of sending the predefined message fails.

15. The method of claim 11, wherein the predefined control command comprises a command of taking at least two photos through at least two cameras.

16. The method of claim 15, further comprising combining the at least two photos when receiving the control signal twice.

17. The method of claim 11, wherein the predefined control command comprises a command of lunching at least two cameras to take videos at the same time.

18. The method of claim 17, further comprising stopping taking videos when receiving the control signal twice.

19. The method of claim 11, wherein the predefined control command comprises a command of taking two photos through two cameras, a command of detecting an average brightness of the two photos, and a command of shutting down one of camera with low brightness.

20. The method of claim 11, further comprising detecting brightness within views of at least two cameras, and employing one camera of the at least two cameras with high brightness.
